(19) United States
(12) Patent Application Publication
(10) Pub. No.: US 2026/0127294 A1
(43) Pub. Date: May 7, 2026

(54) Data Protection Method and Data Protection Device

(71) Applicant: ASUSTeK COMPUTER INC., Taipei City (TW)

(72) Inventor: Yi-Xuan He, Taipei City (TW)

(73) Assignee: ASUSTeK COMPUTER INC., Taipei City (TW)

(21) Appl. No.: 18/926,331

(22) Filed: Oct. 25, 2024

(30) Foreign Application Priority Data
Nov. 7, 2023 (TW) 112142838

(51) Int. Cl. G06F 21/60; G06F 21/64

(52) U.S. Cl. CPC G06F 21/602; G06F 21/64

(57) ABSTRACT

A data protection method and a data protection device are provided according to the disclosure. The method includes: obtaining original data; generating, by a secret key generator, secret key information according to a plurality of parameters, wherein the secret key generator is implemented based on a native code and stored in a Java native interface (JNI) native library, and the parameters includes at least certificate information and signature validity information related to a package file; encrypting the original data by using the secret key information to obtain cipher data; and storing the cipher data in the package file.

### CROSS-REFERENCE TO RELATED APPLICATION

This application claims the priority benefit of Taiwan application serial no. 112142838, filed on Nov. 7, 2023. The entirety of the above-mentioned patent application is hereby incorporated by reference herein and made a part of this specification.

### BACKGROUND

### Technical Field

The application relates to a data protection technology, and in particular, to a data protection method and a data protection device.

### Description of Related Art

The development of most mobile applications requires the use of certain confidential information in the code depending on its functionality, such as passwords, keys, sensitive images, etc. used for server access. This important information must be protected to prevent the leakage of secrets after the application is cracked, resulting in serious security and financial losses. Generally speaking, this confidential information will be protected via an encryption system, such as using a key to encrypt and decrypt the data to be protected. However, once the key stored in the application or server is obtained by a hacker, the above data protection mechanism will be invalid. And the basic program reverse engineering techniques are often very easy to crack the above protection mechanisms.

### SUMMARY

The disclosure provides a data protection method, which includes: obtaining original data; generating, by a secret key generator, secret key information according to a plurality of parameters, wherein the secret key generator is implemented based on a native code and stored in a Java native interface (JNI) native library, and the parameters includes at least certificate information and signature validity information related to a package file; encrypting the original data by using the secret key information to obtain cipher data; and storing the cipher data in the package file.

The disclosure also provides a data protection device, which includes a storage circuit and a processor. The storage circuit is configured to store a JNI native library. The processor is coupled to the storage circuit. The processor is configured to: obtaining original data; generating, by a secret key generator, secret key information according to a plurality of parameters, wherein the secret key generator is implemented based on a native code and stored in the JNI native library, and the parameters includes at least certificate information and signature validity information related to a package file; encrypting the original data by using the secret key information to obtain cipher data; and storing the cipher data in the package file.

Based on the above, the secret key generator can generate the secret key information according to a plurality of parameters. Especially, the secret key generator is implemented based on the native code and stored in a Java native interface native library. Besides, the parameters include at least certificate information and signature validity information related to the package file. Then, the secret key information is used to encrypt the original data to obtain cipher data, and the cipher data is stored in the package file. In this way, better data protection capabilities can be provided for the original data.

### BRIEF DESCRIPTION OF THE DRAWINGS

FIG. 1 is a schematic diagram of a data protection device according to an embodiment of the present disclosure.

FIG. 2 is a schematic diagram of a secret key information generated by the secret key generator according to an embodiment of the present disclosure.

FIG. 3 is a timing diagram of generating the secret key information according to an embodiment of the present disclosure.

FIG. 4 is a schematic diagram of generating the cipher data by an encryptor according to an embodiment of the present disclosure.

FIG. 5 is a schematic diagram of restoring the original data by a decryptor according to an embodiment of the present disclosure.

FIG. 6 is a flow chart of a data protection method according to an embodiment of the present disclosure.

### DESCRIPTION OF THE EMBODIMENTS

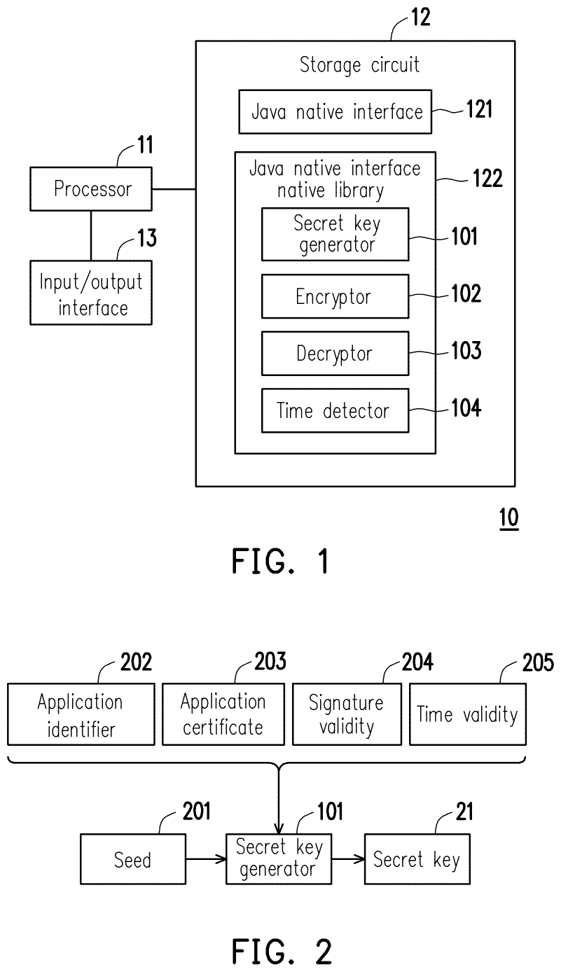

Referring to FIG. 1, the data protection device 10 can be various electronic devices with data processing and computing functions, such as smartphones, tablets, laptops, game consoles, head-mounted displays, smart TVs, industrial computers or servers, and the type of the data protection device 10 is not limited thereto.
the data protection device 10 includes a processor 11, a storage circuit 12 and an Input/Output (I/O) interface 13. The processor 11 is responsible for the entire or partial operation of the data protection device 10. For example, the processor 11 may be Central Processing Unit (CPU), Graphics Processing Unit (GPU), or other programmable general-purpose or special-purpose microprocessor, Digital Signal Processor (DSP), programmable Controllers, Application Specific Integrated Circuits (ASICs), Programmable Logic Devices (PLD) or other similar devices or combinations of these devices.

The storage circuit 12 is coupled to the processor 11 and used to store data. For example, the storage circuit 12 may include a volatile storage circuit and a non-volatile storage circuit. The volatile storage circuit is used to store data volatilely. For example, the volatile storage circuit may include Random Access Memory (RAM) or similar volatile storage medium. The non-volatile storage circuit is used to store data non-volatilely. For example, the non-volatile storage circuit may include Read Only Memory (ROM), Solid State Disk (SSD), Hard disk drive (HDD), or similar non-volatile storage medium.

The I/O interface 13 is coupled to the processor 11 and used to receive and/or output signals. For example, the I/O interface 13 may include various input/output devices, such as a screen, camera, microphone, speaker, mice, keyboard, trackpad, communication interface, and power interface, and the type of the I/O interface 13 is not limited thereto.

In an embodiment, a Java Native Interface (JNI) 121 and a JNI native library 122 are stored in the storage circuit 12. The JNI 121 can be used to access (i.e. call) the JNI Native Library 122. For example, the processor 11 can access the JNI native library 122 via the JNI 121. The JNI 121 the JNI native library 122 can be compiled based on native codes such as C or C++.

In an embodiment, a secret key generator 101, an encryptor 102 and a decryptor 103 are stored in the storage circuit 12. The secret key generator 101 is used to dynamically generate secret key information. The encryptor 102 is used to encrypt data. The decryptor 103 is used to decrypt data. In an embodiment, the secret key generator 101, the encryptor 102 and the decryptor 103 are all compiled based on native codes and stored in the JNI Native Library 122.

In an embodiment, the storage circuit 12 also stores a time detector 104. The time detector 104 is used to verify the time taken by the secret key generator 101 to perform a specific operation. In an embodiment, the time detector 104 is also compiled based on native codes and stored in the JNI Native Library 122.

In an embodiment, the processor 11 can obtain the data to be encrypted (also known as original data). For example, the original data may include textual data, image data or other types of data, the disclosure is not limited thereto.

In an embodiment, the processor 11 can dynamically generate the secret key information via the secret key generator 101. For example, the processor 11 can call the secret key generator 101 via the JNI 121 to start the secret key generator 101. After starting the secret key generator 101, the processor 11 can dynamically generate the secret key information according to a plurality of parameters via the secret key generator 101.

In an embodiment, after generating the secret key information, the processor 11 can encrypt the original data via the encryptor 102 to generate encrypted data (also known as cipher data). For example, the processor 11 may call the encryptor 102 via the JNI 121 to start the encryptor 102. After starting the encryptor 102, the processor 11 may use the secret key information to encrypt the original data via the encryptor 102 to generate the cipher data.

In an embodiment, after generating the cipher data, the processor 11 may store the cipher data in a package file. For example, the package file may include an Android Package (APK) file or other types of compressed files. Taking the APK as an example, the package file can contain information about a specific application (such as, the program code of the application, the identifier of the application, the certificate information of the application, the version information of the application, etc.) and can be used to install the specific application. In an embodiment, the processor 11 can also store the cipher data in any storage space in the storage circuit 12 or other electronic devices (such as a remote server).

In an embodiment, after generating the secret key information, the processor 11 can also decrypt the cipher data via the decryptor 103 to restore the original data. For example, the processor 11 may call the decryptor 103 via the JNI 121 to start the decryptor 103. After starting the decryptor 103, the processor 11 can use the secret key information to decrypt the cipher data via the decryptor 103 to restore the original data.

Referring to FIG. 2, in an embodiment, the secret key generator 101 can calculate and generate secret key information 21 according to at least one of the parameters 201-205. The parameter 201 includes seed information. For example, the seed information can be generated through a random number generator or any other method, the disclosure is not limited thereto. The seed information can change the secret key information 21. Therefore, different seed information can be used to generate multiple sets of keys.

In an embodiment, the seed information can be bound or paired with the original data. For example, specific seed information can be bound or paired with specific original data, and/or specific seed information can be bound or paired with different original data. Alternatively, in an embodiment, the seed information may be bound or paired with the package file. For example, specific seed information can be bound or paired with specific package file, and/or specific seed information can be bound or paired with different package file.

The parameter 202 includes identifier information related to the package file. For example, the processor 11 can read the identifier of a specific application from the package file and generate the parameter 202 based on the identifier. The parameter 203 includes certificate information related to the package file. For example, the processor 11 can read the certificate information of a specific application from the package file and generate the parameter 203 based on the certificate information.

The parameter 204 includes signature validity information related to the package file. In an embodiment, the processor 11 can perform validity verification on a digital signature of the package file (that is, verify the integrity of the file content of the package file) and generate the signature validity information based on the verification results. In other words, the signature validity information may reflect the verification results of the digital signature validity of the package file. In an embodiment, the signature validity information may also reflect the data integrity of the package file (such as, whether the file contents of the package file have been tampered with).

In an embodiment, the processor 11 can obtain digital signature information (such as signature value information and/or public key information) from the certificate information. The processor 11 can calculate hash information based on the file contents of the package file. Then, the processor 11 can calculate and generate the signature validity information based on the digital signature information (such as signature value information and/or public key information) and the hash information.

In an embodiment, the processor 11 can obtain the signature validity information according to the following equation (1.1).

$$sigValid = CKS - ( {sig}^{e} mod N ) \qquad ( 1.1 )$$

In equation (1.1), sigValid is the signature validity information, CKS is the hash information, sig is the signature value information, and (e, N) is the public key information. It should be noted that, equation (1.1) can also be adjusted according to practical needs, the disclosure is not limited thereto.

The parameter 205 includes time validity information. In an embodiment, the processor 11 can obtain the time validity information via the time detector 104. For example, the processor 11 can call the time detector 104 via the JNI 121 to start the time detector 104. After starting the time detector 104, the processor 11 can obtain the time validity information via the time detector 104 during the process of dynamically generating the secret key information.

In an embodiment, the secret key generator 101 can obtain the parameters 202˜204 within a period of time. The time detector 104 can generate the time validity information (i.e. the parameter 205) based on the period of time. The time validity information can reflect whether the period of time complies with the specification. For example, the time validity information can reflect whether the period of time is less than a critical value or within a specific numerical interval.

It should be noted that, in an embodiment of FIG. 2, at least one of the parameters 201-205 can also be ignored. For example, in an embodiment, the parameter 202 and/or 205 may be ignored for performance reasons. Besides, more types of information can also be added as new parameters to the secret key generator 101 to generate the secret key information 21, the disclosure is not limited thereto.

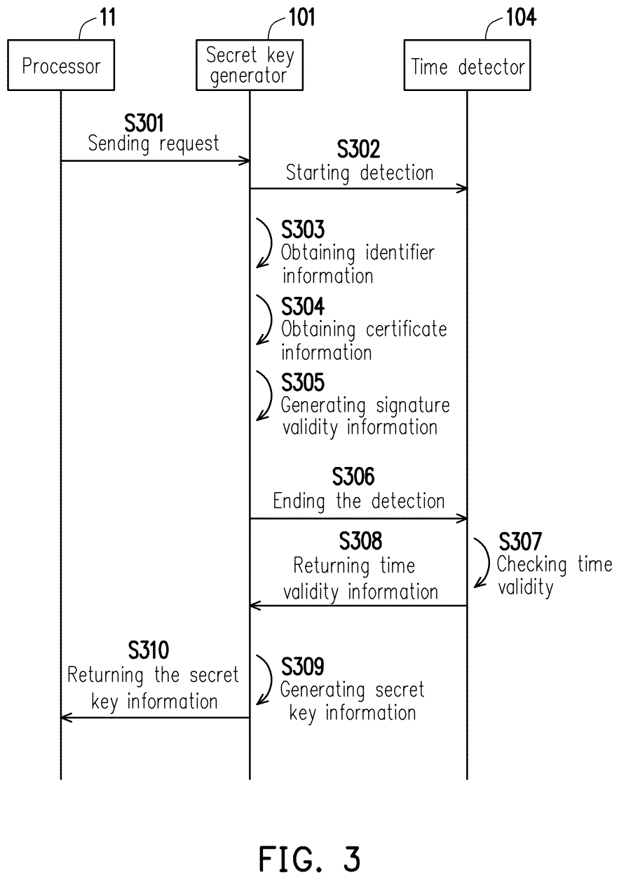

Referring to FIG. 3, in step S301, the processor 11 sends a request to the secret key generator 101 to instruct the secret key generator 101 to perform a key generation operation. The key generation operation is used to dynamically generate the cipher data. For example, the request can carry the seed information. In response to the request, in step S302, the secret key generator 101 requests the time detector 104 to start detection. For example, the time detector 104 will record a timestamp (also known as a first timestamp). The first timestamp can reflect a starting time point of the key generation operation (that is, the time point when the secret key generator 101 starts executing steps S303-S305). Then, in steps S303-S305, the secret key generator 101 obtains the identifier information, the certificate information and the signature validity information in sequence. It should be noted that, the execution sequence of steps S303-S305 can be adjusted according to practical needs, the disclosure is not limited thereto.

After completing steps S303-S305, in step S306, the secret key generator 101 requests the time detector 104 to end detection. For example, in response to the completion of steps S303-S305, the time detector 104 will record another timestamp (also known as a second timestamp). The second timestamp can reflect a completion time point of steps S303-S305 (that is, the time point when steps S303-S305 are completed).

In step S307, the time detector 104 can generate time validity information according to the time difference (i.e., the time difference between the first timestamp and the second timestamp) between a start time and a completion time of the key generation operation (i.e., steps S303-S305). For example, the time validity information can reflect whether the time difference between the first timestamp and the second timestamp is less than a critical value or within a specific value interval. In step S308, the time detector 104 can return the time validity information to the secret key generator 101. In step S309, the secret key generator 101 generates the secret key information according to the obtained information (i.e., the parameters 201-205 in FIG. 2). In step S310, the secret key generator 101 returns the generated secret key information to the processor 11.

In an embodiment, the secret key generator 101 can generate the secret key information according to the following equation (2.1).

$$SK = f ( seed , appID , cert , sigValid , timeValid ) \qquad ( 2.1 )$$

In equation (2.1), SK is the secret key information, seed is the seed information, appID is the identifier information, cert is the certificate information, sigValid is the signature validity information, timeValid is the time validity information, and f( ) is an operation function. For example, f( ) can be a one-way hash function. It should be noted that, equation (2.1) can also be adjusted according to practical needs, the disclosure is not limited thereto.

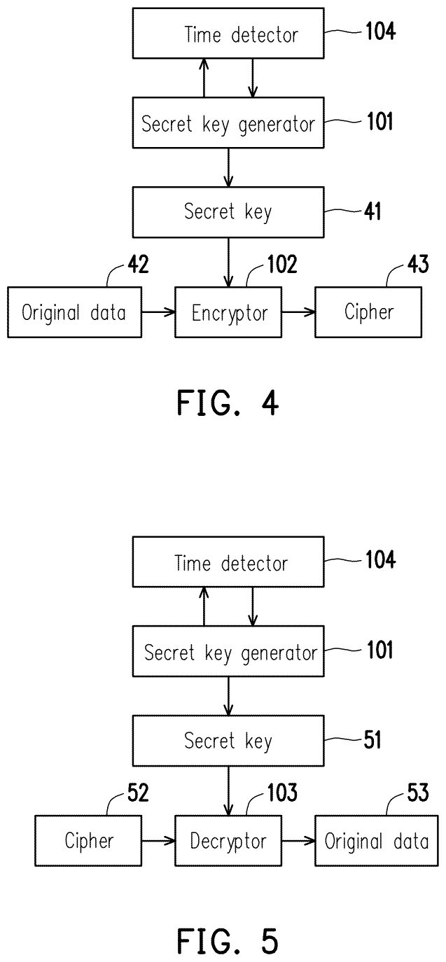

Referring to FIG. 4, in an embodiment, the secret key generator 101 and the time detector 104 can dynamically generate secret key information 41 according to the operation process of FIG. 3. The secret key information 41 can be used to encrypt original data 42. For example, after dynamically generating the secret key information 41, the secret key generator 101 may provide the secret key information 41 to the encryptor 102. The encryptor 102 may encrypt the original data 42 using the secret key information 41 to generate cipher data 43. In an embodiment, the encryptor 102 may also use the secret key information 41 and the seed information to encrypt the original data 42 to generate the cipher data 43.

In an embodiment, the encryptor 102 can generate the cipher data according to the following equations (3.1) or (3.2).

$$CI = En ( sDate , SK ) \qquad ( 3.1 )$$

$$CI = En ( seed , sDate , SK ) \qquad ( 3.2 )$$

In equations (3.1) and (3.2), CI is the cipher data, sData is the original data, and Eno is an operation function. For example, Eno can be an Advanced Encryption Standard (AES) encryption algorithm. It should be noted that, equations (3.1) and (3.2) can also be adjusted according to practical needs, the disclosure is not limited thereto.

Referring to FIG. 5, in an embodiment, the secret key generator 101 and the time detector 104 can dynamically generate secret key information 51 according to the operation process of FIG. 3. The secret key information 51 can be used to decrypt cipher data 52. For example, after dynamically generating the secret key information 51, the secret key generator 101 may provide the secret key information 51 to the decryptor 103. The decryptor 103 can use the secret key information 51 to decrypt the cipher data 52 to restore the original data 53. In an embodiment, the decryptor 103 can also use the secret key information 51 and the seed information to decrypt the cipher data 52 to restore the original data 53.

In an embodiment, the decryptor 103 can restore the original data according to the following equations (4.1) or (4.2).

$$sData = De ( CI , SK ) \qquad ( 4.1 )$$

$$sData = De ( seed , CI , SK ) \qquad ( 4.2 )$$

In equations (4.1) and (4.2), De( ) is an operation function. For example, De( ) can be an AES decryption algorithm. It should be noted that, equations (4.1) and (4.2) can also be adjusted according to practical needs, the disclosure is not limited thereto.

In an embodiment, when the original data needs to be encrypted, the processor 11 can first obtain the seed information. According to the seed information, the processor 11 can dynamically generate the secret key information through the secret key generator 101 (and the time detector 104). After obtaining the secret key information, the processor 11 can encrypt the original data through the encryptor 102 to obtain the cipher data.

In an embodiment, after generating the cipher data, the processor 11 can store the cipher data and the seed information used to generate the cipher data in the package file or other storage space. It should be noted that, in an embodiment, after generating the cipher data, the processor 11 does not need to store the secret key information to prevent it from being stolen by hackers.

In an embodiment, when the original data needs to be restored, the processor 11 can read the seed information and the cipher data from the package file or other storage space. According to the seed information, the processor 11 can dynamically generate the secret key information through the secret key generator 101 (and the time detector 104) again. After obtaining the secret key information, the processor 11 can decrypt the cipher data through the decryptor 103 to restore the original data.

It should be noted that, the aforementioned operations of generating the secret key information, encrypting the original data to obtain the cipher data, and decrypting the cipher data to restore the original data have all been described in detail above and will not be repeated here. For example, the operation of generating the secret key information may refer to the description of the embodiments of FIG. 2 and FIG. 3, the operation of encrypting the original data to obtain the cipher data may refer to the description of the embodiment of FIG. 4, and/or the operation of decrypting the cipher data to restore the original data may refer to the description of the embodiment of FIG. 5.

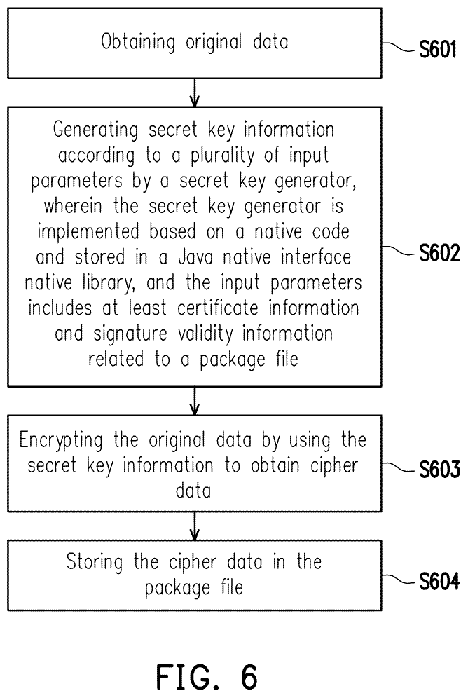

Referring to FIG. 6, in step S601, original data is obtained. In step S602, secret key information is generated by a secret key generator according to a plurality of parameters, where the secret key generator is implemented based on a native code and stored in a JNI native library, and the parameters includes at least certificate information and signature validity information related to a package file. In step S603, the secret key information is used to encrypt the original data to obtain cipher data. In step S604, the cipher data is stored in the package file.

However, each step in FIG. 6 has been described in detail above and will not be repeated here. It is worth noting that each step in FIG. 6 can be implemented as multiple codes or circuits, the disclosure is not limited thereto. In addition, the method of FIG. 6 can be used in conjunction with the above example embodiments or can be used alone, the disclosure is not limited thereto.

In summary, the data protection method and the data protection device provided by the embodiments of the present disclosure, which can dynamically generate the secret key information when needed to encrypt the original data or decrypt the cipher data. During the encryption or decryption operation, the secret key information is not stored or read in any static form to prevent the secret key information from being leaked or stolen. In addition, at least some of the parameters used to dynamically generate the secret key information can be bound to part of the file content (such as certificate information and/or digital signature) of a specific package file (such as an APK file), thereby increasing the difficulty of cracking the secret key information. In this way, better data protection capabilities can be provided for the original data.

Although the present invention has been disclosed with reference to the embodiments, it is not intended to limit the present invention. Those skilled in the art may make some modifications and refinements within the spirit and scope of the present invention. Therefore, the scope of protection of the present invention shall be determined by the appended claims.

What is claimed is:

1. A data protection method, comprising:
obtaining original data;
generating, by a secret key generator, secret key information according to a plurality of parameters, wherein the secret key generator is implemented based on a native code and stored in a Java native interface (JNI) native library, and the parameters includes at least certificate information and signature validity information related to a package file;
encrypting the original data by using the secret key information to obtain cipher data; and
storing the cipher data in the package file.

2. The data protection method according to claim 1, wherein the parameters further comprise seed information, and step of encrypting the original data by using the secret key information to obtain the cipher data comprises:
encrypting the original data by using the secret key information and the seed information to obtain the cipher data.

3. The data protection method according to claim 1, further comprises:
obtaining digital signature information from the certificate information;
calculating hash information according to file contents of the package file; and
generating the signature validity information according to the digital signature information and the hash information.

4. The data protection method according to claim 1, wherein the parameters further comprise time validity information, and the data protection method further comprises:
obtaining the certificate information and the signature validity information by the secret key generator within a period of time; and
generating the time validity information according to the period of time by a time detector.

5. The data protection method according to claim 1, further comprises:
calling the secret key generator via a Java native interface to start the secret key generator.

6. The data protection method according to claim 1, further comprises:
decrypting the cipher data by using the secret key information to restore the original data.

7. The data protection method according to claim 6, wherein the parameters further comprise seed information, and the step of decrypting the cipher data by using the secret key information to restore the original data comprises:
decrypting the cipher data by using the secret key information and the seed information to restore the original data.

8. A data protection device, comprising:
a storage circuit, configured to store a Java native interface (JNI) native library; and
a processor, coupled to the storage circuit,
wherein the processor is configured to:
obtaining original data;
generating, by a secret key generator, secret key information according to a plurality of parameters, wherein the secret key generator is implemented based on a native code and stored in the JNI native library, and the parameters includes at least certificate information and signature validity information related to a package file;
encrypting the original data by using the secret key information to obtain cipher data; and
storing the cipher data in the package file.

9. The data protection device according to claim 8, wherein the parameters further comprise seed information, and the operation of the processor encrypting the original data by using the secret key information to obtain the cipher data comprises:
encrypting the original data by using the secret key information and the seed information to obtain the cipher data.

10. The data protection device according to claim 8, wherein the processor is further configured to:
obtaining digital signature information from the certificate information;
calculating hash information according to file contents of the package file; and
generating the signature validity information according to the digital signature information and the hash information.

11. The data protection device according to claim 8, wherein the parameters further comprise time validity information, and the processor is configured to:
obtaining the certificate information and the signature validity information by the secret key generator within a period of time; and
generating the time validity information according to the period of time by a time detector.

12. The data protection device according to claim 8, wherein the processor is further configured to:
calling the secret key generator via a Java native interface to start the secret key generator.

13. The data protection device according to claim 8, wherein the processor is further configured to:
decrypting the cipher data by using the secret key information to restore the original data.

14. The data protection device according to claim 13, wherein the parameters further comprise seed information, and the operation of the processor decrypting the cipher data by using the secret key information to restore the original data comprises:
decrypting the cipher data by using the secret key information and the seed information to restore the original data.
